(19) United States
(12) Patent Application Publication
(10) Pub. No.: US 2021/0227398 A1
(43) Pub. Date: Jul. 22, 2021

(54) SYSTEM AND METHOD FOR ESTABLISHING AND MAINTAINING WIRELESS COMMUNICATION IN SIGNAL DEPRIVED ENVIRONMENTS

(71) Applicant: ShadowTech Labs, Willowbrook, IL (US)

(72) Inventors: David Nahlik, Chicago, IL (US); Michael Collins, Chicago, IL (US); Dennis Collins, Park Ridge, IL (US)

(21) Appl. No.: 17/196,819

(22) Filed: Mar. 9, 2021

Related U.S. Application Data
(63) Continuation-in-part of application No. 17/017,116, filed on Sep. 10, 2020.
(60) Provisional application No. 62/898,412, filed on Sep. 10, 2019.

(51) Int. Cl. H04W 16/18; H04B 17/318

(52) U.S. Cl. CPC H04W 16/18; H04B 17/318

(57) ABSTRACT

A system and method for establishing a communications network include a main communication radio configured to be operated from a base location in or near a signal deprived environment, one or more personnel radios configured to be carried by a corresponding number of personnel operating within the signal deprived environment, and a plurality of wireless communication devices configured to be carried by the personnel. Each of the plurality of wireless communication devices can be selectively deployed as a deployed device within the signal deprived environment by the personnel, from the base location, or automatically, based on a signal strength of a monitored signal falling to or below a minimum signal threshold. The communications network is established and/or maintained between the main communication radio and the one or more personnel radios and/or between the one or more personnel radios through any one or more of the deployed devices of the plurality of wireless communication devices.

### RELATED APPLICATION DATA

This patent is a continuation-in-part of, is entitled to the benefit of, and claims priority to co-pending U.S. application Ser. No. 17/017,116 filed Sep. 10, 2020, which claims the benefit of and priority to U.S. Provisional Application Ser. No. 62/898,412 filed Sep. 10, 2019, each entitled “Apparatus, System, and Method for Establishing and Maintaining Wireless Communication in Signal Deprived Environments.” The entire contents of these prior filed application are hereby incorporated herein by reference.

### BACKGROUND

### 1. Field of the Disclosure

The present disclosure is generally directed to electronic communications in signal deprived environments, and more particularly to an apparatus, system, and method for establishing and maintaining wireless communication in such environments.

### 2. Description of Related Art

Improvised Explosive Devices (IEDs) are used extensively throughout the world by terrorists, drug cartels, hostile military units, and the like IEDs are an inexpensive, low-tech method used to raise apprehension and inflict causalities in personnel and to damage equipment. Numerous solutions have been devised and implemented for detecting and disarming such IEDs, which may be found on or beside roads, in or near buildings, in tunnels and caves, in marine vessels, in mountainous regions, or in dense urban areas, or contained in vehicles. Such solutions have been fielded and deployed with varying degrees of success.

Conducting clearing and search operations for such IEDs and other dangers within signal deprived environments, such as caves, tunnels, bunkers, mountainous regions, densely packed urban surroundings, ships, buildings, and the like has been a long-standing problem for operators in high-risk environments. Adequate equipment is lacking for systems that are used to search and/or clear tunnels and caves of booby traps and armed hostile personnel. Traditional methodologies have included both human and machine, i.e., robot clearing and/or search options. Placing human operators in harm's way (i.e., entering confined spaces or uncleared areas) is never an optimal option. Remotely operated systems have thus been developed to alleviate such risks to personnel. However, remotely operated solutions have too often proven unreliable. This has forced human operators into danger zones to recover failed remotely controlled systems or to manually continue clearing and/or search missions. When forced to do so, human operators have also had communication difficulties with the control or head end of an operation in such signal deprived environments.

Remote system options include operating a robot and directing the robot into signal deprived and high danger or high-risk environments. Remote system options can be broken down into two (2) broad types: tethered systems and radio-controlled systems. Both options have advantages and disadvantages. These options are discussed briefly below.

A tethered system deploys a remotely controlled unit that is physically connected to a control or head end unit for power and communication. Tethered systems rely on a cable trailing the remote-controlled vehicle or unit, which carries other system devices. The cable provides power, control, and sensor and device interface for video assessment, infra-red sensors, voice communications, and the like. When used in a clean environment, the tethered systems generally have proven to be an acceptable option. However, when used in caves, ships, other difficult environments, or in battle-damaged or ongoing battle areas, the tethered system has proven to be inadequate. The cable is a liability because it tends to snag or hang up on objects within the environment. Also, the cable has a finite length, which limits the functional range of such a system.

In a tethered system, if the cable is too short, the operator may need to enter the cave, tunnel, or other confined space along with the remote unit. The detonation of an TED or engagement with hostile personnel could result in catastrophic damage to friendly forces tasked with the clearing and/or searching operations. For example, forces within the blast zone would be rendered combat ineffective or possibly killed as a result of an unplanned detonation. If the tether becomes snagged or hung up on an object, the remote unit may not be able to proceed forward or to be retrieved by remote control.

A radio-controlled system (RCS), unlike the tethered system, relies on a radio transmitter/receiver located at both the head end control unit and the remotely controlled unit. The radio allows the controller to communicate with the remotely controlled unit and to monitor data, audio communications, and video over a radio frequency (RF). However, caves, tunnels, bunkers, ships, mountainous regions, signal deprived urban regions, and other such areas create signal deprived pockets and environments where the ability to communicate with or along the RCS is greatly reduced by distance, corners, elevation changes, and other RF obstructions. An RCS basically depends on line-of-sight for reliable operation. These signal deprived areas present point-to-point radio communication limitations, which frustrates command, control, communication, and computer (C4) abilities. The ability to communicate is reduced or lost as the radio remote-controlled vehicle or unit of the RCS loses line of sight with the controller or operator and thus loses communication with the head end or control unit.

Tunnels, caves, mountainous regions, dense urban settings, and other such areas rarely provide a RF friendly environment. Increases or decreases in elevation and obstructions, curves, twists, and turns become signal deprived or signal denial zones. For the robot unit or remote-controlled device to maintain communications with the control unit, the operator is forced to move into the confined space or dangerous zone to continue communications with the robot unit or remote-controlled device. The operator may also have the same difficulties in communicating with the control or head end as they move about the signal deprived environment.

Currently employed solution sets are also expensive, require significant manpower, consume high power, and require highly skilled operation. Some systems rely on a fixed network of transmission stations, i.e., a mesh network, which employs fixed position or stationary communication nodes or devices. Most solutions for signal deprived environments, however, rely on mobile ad hoc network (MANET) radios. These systems rarely allow for high bandwidth operations and can cost upwards of $15,000 per radio or communication unit. These systems also require extensive, expensive training and high levels of power. It is also often standard operating procedure (SOP) to leave personnel in place to operate and/or protect these relays, which is costly in usurping valuable manpower and resources.

### SUMMARY

In one example, according to the teachings of the present disclosure, a system for establishing and maintaining a communications network includes a main communication radio configured to be operated from a base location in or near a signal deprived environment, one or more personnel radios configured to be carried by a corresponding number of personnel operating within the signal deprived environment, and a plurality of wireless communication devices configured to be carried by the personnel. Each of the plurality of wireless communication devices can be selectively deployed as a deployed device within the signal deprived environment by the personnel, from the base location, or automatically through wireless communication with the base location based on a signal strength of a monitored signal falling to or below a minimum signal threshold. The communications network is established and/or maintained between the main communication radio and the one or more personnel radios and/or between the one or more personnel radios through any one or more of the deployed devices of the plurality of wireless communication devices.

In one example, each of the deployed devices of the plurality of wireless communication devices can automatically activate when deployed.

In one example, each of the deployed devices of the plurality of wireless communication devices can be configured to be manually activated when deployed.

In one example, the system can include a dispensing device carried by the personnel. The dispensing device can be configured to hold and/or selectively eject or dispense the plurality of wireless communication devices.

In one example, the dispensing device can include a magazine holding the plurality of wireless communication devices. In one example, a spent magazine can be replaced on the dispensing device with a loaded magazine. In one example, a spent magazine can be reloaded on the dispensing device with a plurality of wireless communication devices.

In one example, the one or more personnel radios can be equipped with one or more of video communication capability, audio communication capability, sensor capability, light emitting capability, and/or infra-red illumination or video capability.

In one example, a signal reduction of the monitored signal is determined based on monitoring Signal-to-Noise Ratio (SNR), signal strength, signal bandwidth, Radio Signal Strength Indicator (RSSI), or any combination thereof.

In one example, one of the plurality of wireless communication devices can be configured to provide a signal or prompt that the signal strength of the monitored signal has fallen to or below the minimum signal threshold.

In one example, according to the teachings of the present disclosure, a method for establishing and maintaining a communications network includes: operating, from a base location, a main communication radio, in or near a signal deprived environment; having one or more personnel operating within the signal deprived environment and each carrying a personnel communication radio; monitoring signal strength between the main communication radio and the personnel communication radios of the one or more personnel and/or between two of the personnel communication radios; deploying a wireless communication device within the signal deprived environment before or upon detection of a signal reduction in the signal strength to or below a minimum signal strength threshold; and further monitoring the signal strength as the one or more personnel operate within the signal deprived environment.

In one example, the method can include repeating, one or more times, the steps of monitoring, deploying, and further operating.

In one example, the signal reduction can be determined based on monitoring Signal-to-Noise Ratio (SNR), signal strength, signal bandwidth, Radio Signal Strength Indicator (RSSI), or any combination thereof.

In one example, the one or more personnel communication radios can be equipped with one or more of video communication capability, audio communication capability, sensor capability, light emitting capability, and/or infra-red illumination or video capability.

In one example, upon being deployed, each deployed device of the plurality of wireless communication devices can automatically activate when deployed.

In one example, upon being deployed, each deployed device of the plurality of wireless communication devices can be manually activated when deployed.

In one example, the step of deploying can include selectively deploying a wireless communication device as a deployed device within the signal deprived environment manually by a monitored personnel, from the base location, or automatically through wireless communication with the base location.

In one example, the method can include the step of providing a prompt or a signal to the one or more personnel being monitored when the signal reduction occurs.

In one example, the step of providing the prompt or signal can include a communication device of a plurality of the wireless communication devices providing the signal or prompt.

In one example according to the teachings of the present disclosure, a method for establishing and maintaining a communications network includes: operating a main communication device in or near a signal deprived environment; having another communication device operating within the signal deprived environment; monitoring signal strength between the main communication device and the other communication device; deploying a wireless communication device within the signal deprived environment before or upon detection of a signal reduction in the signal strength to or below a minimum signal strength threshold; and further monitoring the signal strength as the other communication device operates within the signal deprived environment.

### BRIEF DESCRIPTION OF THE DRAWINGS

The drawings provided herewith illustrate one or more examples or embodiments of the disclosure and therefore should not be considered as limiting the scope of the disclosure. There may be other examples and embodiments that may be equally effective to achieve the objectives and that may fall within the scope of the disclosure. Objects, features, and advantages of the present invention will become apparent upon reading the following description in conjunction with the drawing figures, in which:

FIG. 1 shows a simplified schematic of one example of a system in accordance with the teachings of the present disclosure and configured to establish and maintain wireless communication within signal deprived environments.

FIG. 2 shows a perspective view of one example of a remote-control vehicle constructed in accordance with the teachings of the present disclosure.

FIG. 3 shows a perspective view of one example of a wireless communication device in accordance with the teachings of the present disclosure and in a deployed and activated state.

FIG. 4 shows a simplified cross-section view of one example of an automated dispenser in accordance with the teachings of the present disclosure and for selectively dispensing the wireless communication devices of FIG. 4.

FIG. 5 shows a schematic view of one example of a communications network established using the components of FIGS. 1-4.

FIG. 6 shows a flow chart of one example of a method of establishing a communications network in accordance with the teachings of the present disclosure.

FIG. 7 shows a schematic view of another example of a communications network established using components according to the teachings of the present disclosure.

FIG. 8 shows another example of a wireless communication device in a carry mode and according to the teachings of the present disclosure.

FIG. 9 shows the wireless communication device of FIG. 8 in one example of a deployed mode.

FIG. 10 shows a flow chart of another example of a method of establishing a communications network in accordance with the teachings of the present disclosure.

The use of the same reference numbers or characters throughout the description and drawings indicates similar or identical components, aspects, and features of the disclosure.

### DETAILED DESCRIPTION OF THE DISCLOSURE

The disclosed apparatus, system, and method solve or improve upon one or more of the above-noted and/or other problems and disadvantages with prior known systems and solutions. The disclosed apparatus is controllable by wireless communication to navigate a signal deprived environment. The disclosed apparatus is also controllable to deploy wireless communication devices, as needed, throughout the signal deprived environment to establish a communications network within such an environment. The disclosed systems allow an operator to operate a remote-control vehicle within a signal deprived environment to maneuver the vehicle and to utilize the various on-board vehicle systems and functions. The disclosed systems allow a warfighter or personnel to manually set up or create a communications network within a signal deprived environment. The disclosed method allows an operator to inspect and investigate a signal deprived environment with a remote-control vehicle by establishing a communications network utilizing the remote-control vehicle and deployable wireless communication devices within the environment. The disclosed methods allow warfighters or personnel to manually establish a communication network within a signal deprived environment. These and other objects, features, and advantages will become apparent to those having ordinary skill in the art upon reading this disclosure.

In the disclosed examples, a system and method are disclosed for establishing and maintaining a network, such as a secure layer 2 network, in a signal deprived environment. The system and method create a bridge or signal path between a first communication device, radio, or the like at one end of the network and a communication device, radio, or the like at another end of the network. The system utilizes deployed nodes or bread crumbs, i.e. wireless communication devices deployed within a signal deprived environment to establish and maintain wireless signal communication between these end units. The nodes or bread crumbs can be deployed to also be deployed to communicate with one another to maintain the signal path and/or to communicate with intermediate communication devices to extend the network where signal loss between network elements or devices would otherwise have occurred. The deployed wireless communication devices provide radio agnostic layer 2 capability to establish and maintain a network where a communication signal would have otherwise been lost.

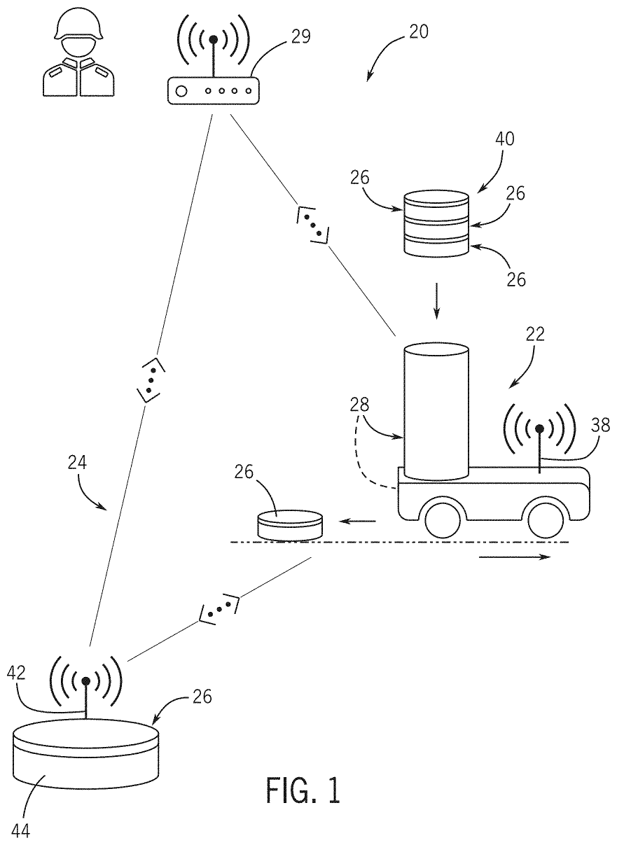

Turning now to the drawings, FIG. 1 shows a generic schematic of one example of a communications network and system constructed and configured according to the teachings of the present disclosure. In one example, an apparatus, a system that utilizes the apparatus, and a method that utilizes the system and apparatus, are disclosed and described herein according to the teachings of the present disclosure. The apparatus, systems, and methods are collectively referred to herein as the Tunnel Rat (the apparatus), the Tunnel Rat systems, or the Tunnel Rat methods for ease of description. In the example of FIG. 1, a Tunnel Rat system 20 is generally configured to establish and maintain wireless communications within signal deprived environments. The Tunnel Rat system 20, more specifically, establishes and maintains a flexible and expandable wireless communications network to enable remote vehicle, and sensor and electronic component suite, operation deep into high risk, signal-deprived, subterranean, and other environments. The Tunnel Rat system 20 provides operators with the capability to conduct clearing and/or search operations within such signal deprived environments and vastly improves safety, reliability, and effectiveness in comparison to existing systems and methods.

In one example, the Tunnel Rat system 20 is composed of multiple primary components or sub-systems. One element or sub-system is a remote-controlled vehicle 22 or unit, i.e., the Tunnel Rat or Tunnel Rat vehicle (TRV). Another element or sub-system is a secure wireless communications network, i.e., the network 24. Yet another element or sub-system is a plurality of wireless communication devices 26, i.e., Tunnel Rat communication pucks (TRCPs). Still another element or sub-system is an automated dispensing device 28 for dispensing the TRCPs 26, i.e., the Automated Puck Dispenser (APD). Yet another element or sub-system is a main control unit or controller 29, controlled by an operator, to operate the TRV 22 and the system and network. These components allow the operator to create an adaptable and expandable communication system.

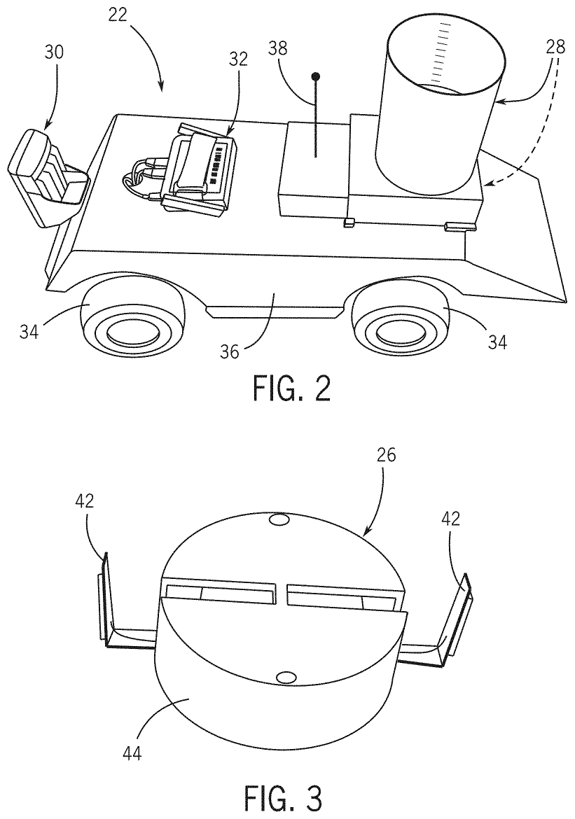

FIGS. 1 and 2 show generic examples of the TRV 22, which is a remotely operated, radio-controlled robotic vehicle. The TRV 22 can provide the tactical warfighter or operator with intelligent reconnaissance deep into signal-deprived environments such as sub-terranean areas, tunnels, caves, bunkers, mountainous regions, dense urban settings, ships, and the like. The TRV 22 can be equipped with various on-board electronic equipment and components 30 and 32. The equipment and components 30 can be configured to provide high-definition video, IR illumination, motion sensor analytics, two-way data communications, and two-way communications for voice/audio/sound. Thus, the TRV 22 can provide video images, audio data, various sensor data, and the like from the location of the TRV. Likewise, the TRV 22 can provide or deliver various electronic and other functions at the location of the TRV, including sound or audio, electronic signals, illumination, and the like. The equipment and components 30 can also include one or more separate processors, as needed, to impart desired functionality to the electronic features and functions of the equipment, components, system, and network. The electronic component 32 can include a wireless transceiver for wirelessly communicating with the network, as it is established, and can include a processor for also providing on-board functionality and features for the TRV and the network.

The TRV 22 can run on a battery (not shown) for continuous operation. The battery type, size, and life can be varied, depending on the needs of a given operation or system purpose. The life or run time duration of the battery can vary depending on the battery characteristics. In one example, the battery can provide at least two (2) hour of continuous operation for the TRV 22 and the on-board electronic components and equipment 30, 32, and their respective functions.

The TRV 22 can include a motor (not shown) and wheels 34, tracks, or the like to permit the TRV to be driven to and throughout a desired area or environment. In another example, the TRV 22 can be a different type of vehicle or remote-control unit, such as a floating or submersible vehicle for water-borne operations or a drone for airborne operations, if desired. The size, shape, and configuration of the TRV 22 can vary considerably within the scope and spirit of the present disclosure. The TRV 22 can include a body 38, which can be lightweight, if desired. The wheels 34 can be solid or air-filled, can vary in size, can be formed of various materials, such as rubber or composite, and can have different types of rolling surfaces, such as treads or the like. The body 36 or shell of the TRV 22, as well as the wheels 34, can be formed of any suitable materials, but in one example can be configured to resist damage from projectiles, shrapnel, explosives, and the like. The TRV 22 can also include, as noted above, one or more on-board processors and/or printed circuit boards (PCBs) to provide and control the motor and the various electronic devices and components 30, 32, and capabilities of the TRV. The TRV 22 can also include an internal antenna or a deployed or extended antenna 38 to enhance signal strength and reception.

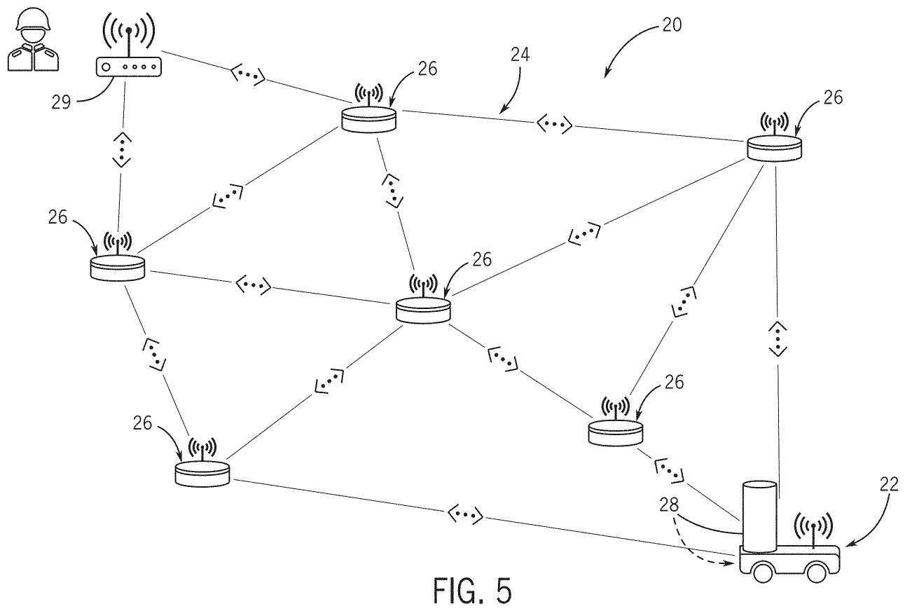

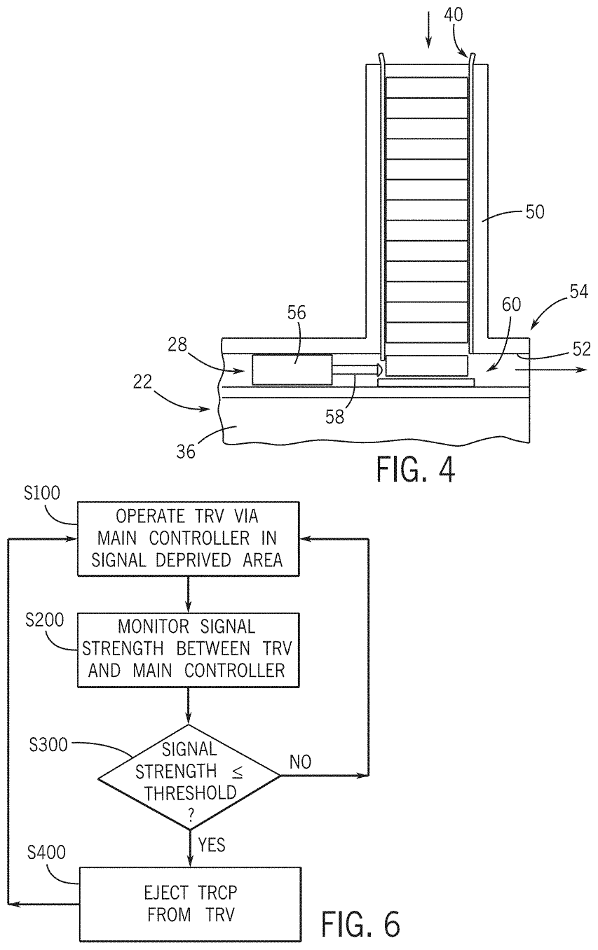

Referring to FIGS. 1 and 3, the TRCPs 26 can be small electronic communication devices, such as pods, pucks, nodes, hand-held radio devices, or the like. The size, shape, or form of the wireless communication devices 26 can vary within the scope of this disclosure. In this example the TRCPs 26 can be manually activated or self-actuating, i.e., be activated or turned on, upon being ejected or dispensed from the APD 28. The TRCPs 26 can also be self-joining or self-connecting to the network. Thus, once ejected or dispensed, each deployed TRCP 26 can automatically join or connect to the network that includes the main controller 29 and the TRV 22. The TRCPs 26 can be small and have a low profile to render them unobtrusive and inconspicuous. The TRCPs 26 can each also include a small on-board power source, such as a battery. The TRCPs 26 can be configured for low power operation in that their only function may be to provide network continuity. Each TRCP 26 can thus also have the minimal requisite on-board electronics, such as a transceiver, necessary to send and receive signals over the network. The TRCPs 26 can include a battery that may provide a predetermined life, such as a minimum of eight (8) hours on battery power. In one example, as discussed further below, the Tunnel Rat or TRV 22, or the APD 28, can carry a cartridge or magazine 40 of the TRCPs 26 as it travels into the signal deprived area (see FIGS. 2 and 4).

In one example as shown in FIG. 3, each TRCP 26 can have one or more on-board antennas 42. The antenna or antennas 42 can be connected to a PCB, transceiver, processor, and/or the like disposed within a case 44 or housing of the TRCP. The antennas 42 can be internal to the TRCP body or can be deployed or deployable from the case 44, as shown in FIG. 3. In one example, the antennas 42 can auto deploy once the TRCP 26 is ejected or dispensed from the TRV 22. FIG. 3 illustrates one example of a TRCP 26 with two antennas 42 that automatically rotate or pivot from the case 44 when deployed from the APD 28. The antennas 42 may be pressure activated.

Each TRCP 26 may be configured to provide self-forming and self-healing features. Accordingly, the TRCPs 26 can be configured to communicate with one another and with the TRV 22 and/or the controller 29 to bypass any single failure point, such as a dead or malfunctioning TRCP 26 (see FIG. 5). The TRCPs 26 can be configured to be relatively low-cost, expendable communication devices that can create and expand the reach of the network. The case 44 or housing of the TRCPs 26 can be made from a material of having a structure that is impact resistant, strong, and durable, if desired. The TRCPs 26 can be deployed throughout the signal deprived area to ensure continuous communication and control of the TRV 22 from the controller 29 for streaming of high definition video, data, voice, and other functions. The TRCPs 26 can be compatible with existing software defined radios and internet protocol (IP) tactical radios, such as HARRIS FALCON III® AN/PRC-152A, TrellisWare, Persistent Systems, Silvus, and the like, via ethernet tether linking.

Referring to FIGS. 1, 2, and 4, the APD 28 can be combined with the cartridge or magazine 40 or can be a separate part of the TRV 22. In one example, the magazine 40 is configured to contain or be loaded with a plurality of the TRCPs 26. The APD 28 may be, may include, or may be coupled to an easily replaceable cartridge or magazine 40 on the TRV 22. In one example, the TRCPs 26 may be loaded into a magazine or cartridge 40 and then the magazine or cartridge may be inserted into a dispenser or housing part of the APD 28 or otherwise attached to the APD or the body of the TRV 22. As the TRV 22 moves through an area to be cleared or searched, all communications with the head end controller 29, i.e., the control unit, can be monitored via the network, as described below.

FIG. 4 shows just one simplified example, of many possible examples, of an ADP 28 and magazine 40 arrangement for the TRV 22. In this example, the body 36 of the TRV 22 includes a receiver stack 50 configured to removably receive a magazine 40 of TRCPs 26 through a top opening of the stack. In this example, the ADP 28 is a mechanism that is configured as a part of the TRV 22. The ADP 28 cooperates with the receiver stack 50 and the magazine 40 to eject a TRCP 26 through an opening 52 at a rear end 54 of the TRV 22. In this example, the ADP 28 can be an electromechanical device or mechanism 56 configured to communicate with the network and the main controller 29. The ADP 28 can also have an ejector 58 that is actuated by the mechanism 56 upon receiving the signal or instructions to eject or dispense a TRCP 26. The magazine 40 may gravity feed or spring feed the loaded TRCPs 26 downward toward the ejector 58. A chute 60 may be aligned with the lowermost TRCP 26, the ejector 58, and the opening 52 in the body 36.

In other examples, the magazine or TRCP stack may be horizontally oriented or may be oriented and stored in different configurations. The TRCPs 26 may also be dropped vertically downward from the TRV 22 or at an angle between vertical and horizontal from the TRV. Further, the ejector 58 may be replaced by a gate or trap door that blocks or releases a TRCP 26 upon being actuated. Further, all or at least part of the ADP 28 may be part of the removable magazine or cartridge and not a part of the TRV 22. Instead, a connector may connect the ADP to the electronics on board the TRV when the magazine or cartridge is installed on the TRV. Other examples and arrangements, and other mechanisms and components may be utilized as the ADP 28 or as a part of the ADP within the spirit and scope of the present disclosure.

As needed, TRCPs 26 can be dispensed manually by the operator or automatically. In one example, as discussed further below, the TRCPs 26 can be auto ejected when communication strength reaches or falls below a predetermined minimum level, based on a bandwidth and/or signal strength threshold. In another example, the TRCPs 26 can also be deployed manually by the operator from the head end controller 29 or control unit based on the same signal strength threshold or at otherwise desirable locations to assure optimal signal strength and quality.

The TRCPs 26 can be loaded in a rapid mounting magazine or cartridge in the APD 28 or on the TRV 22, may be loaded directly into the APD, or may be pre-loaded into a magazine or cartridge that is then installed in or coupled to the APD. The APD 28 may be capable of mounting to a standard U.S. military mounting unit or a similar mount. The APD 28 may be configured as a part of a uniquely design TRV 22 with an integrated APD 28 or can be configured to be adapted to existing radio-controlled vehicles or units. The APD 28 can be configured such that the TRCPs 26 are separately and automatically ejected from the APD, based on signal monitoring presets, such as a Signal-to-Noise Ratio (SNR) measurement or threshold or the like. In one example, the TRCPs 26 can be ejected or dispensed directly below the TRV 22 and/or the APD 28. Alternatively, as represented in FIG. 1, the TRCPs 26 can be ejected or dispensed rearward, forward, or sideways in a horizontal or semi-horizontal direction. The TRCPs 26 can be loaded and/or stored in vertical stacks, horizontal rows, or both in the APD 28.

Referring to FIGS. 1 and 5, the communications network 24 can be configured to provide a self-forming and self-healing mobile ad hoc network (MANET) or mesh network. In other words, the components (control unit 29, TRV 22, and TRCPs 26) can communicate with any of the other components in the network, as needed, to maintain an adequate signal between the control unit and the TRV. FIG. 6 shows only some of the possible different self-formed signal routes that may be achieved within a representative network 24 to establish and maintain communication. The system 20 and network 24 can self-form and self-heal, as needed, to provide adequate signal strength and bandwidth and to bypass failed, malfunctioning, or signal deprived TRCPs 26. The network 24 includes the head end controller 29 or control unit manned by an operator. The network 24 in this example also includes the TRV 22 that is remotely operated by the operator via the control unit 29. As the TRV 22 and control unit 29 become separated by distance and are faced with signal obstructions, the network 24 further includes one or more of the deployed TRCPs 26, ejected as and where needed, to establish and maintain communication between the TRV and the control unit.

The network 24 can be configured to deliver 600 MBPS, in one example, to allow high-definition video, data, voice, and other electronic transmission. The network 24 can be secure and encrypted. In one example, the network 24 can be configured using CTR-AES-256 Encryption, HMAC-SHA-256 Authentication & Integrity+Utilizes Suite-B Algorithms+Cryptographically authenticated Over-the-Air Rekey and Key Zero.

The network 24, which may be identified as a secure MANET radio system for signal deprived areas (SMRSSDA), can be configured to provide reliable communication in signal deprived areas such as caves, tunnels, bunkers, mountainous regions, dense urban areas, ships, and the like. The network 24 can be relatively low cost, secure, high band width, rapidly deployable, modularly expandable, and easy to operate. The TRCPs 26 can be small, lightweight, and expendable devices. The TRCPs 26 can be configured to be manually or automatically destroyed or to self-destruct. The on-board electronics can be erased, fried, burned, and/or exploded upon expiration or depletion of power or through manual communication from the control unit 29.

The SMRSSDA network 24 can be seamlessly and easily employed in the field. As operators encounter signal deprived areas, they can simply drop a TRCP 26 into place using the TRV 22, or manually if moving within such an area, as discussed further below. In this example, the TRCPs 26 can be configured to automatically activate once deployed. Alternatively, the operator may be required to activate a deployed TRCP 26 from the controller. The network 24 then instantly forms or reforms. This links the tethered SMRSSDA worn or controlled by an operator to the rest of the network 24. An existing network may be linked to a remote field TRV 22 and TRCPs 26 in this manner as well. Operators can continue to add to and expand the network 24 as the environment dictates by deploying TRCPs 26 as needed. Upon completion of a mission, the operators may collect deployed TRCPS 26, if desired and if able, for future use. Alternatively, the operators can send a “zero” command to the deployed TRCPs 26, and the TRV 22, if needed, leaving the units, components, and devices purged of all encryption and software and rendering them essentially useless. Alternatively, the operators can send a “burn” command, which can both “zero” the selected units, components, and devices and physically destroy them in place. Alternatively, the deployed TRCPs 26, and TRV 22 if needed, may be configured to automatically self-destruct at a certain low battery level, passage of a predetermined time period, or the like.

In one example, the disclosed system 20 incorporates a SNR algorithm or monitoring program. The Tunnel Rat system's SNR can be coupled with a monitoring system to maintain and optimize signal quality back to the head end 29, controller, or control unit. The TRV 22 can include on-board software that monitors the signal strength and/or bandwidth or SNR in real time. When the TRV 22 determines that the signal strength and/or bandwidth has dropped to or below a predetermined level, i.e., a signal strength and/or bandwidth minimum threshold, the TRV and/or the APD 28 will automatically drop a wireless communication device, i.e., a TRCP 26. The TRCPs 26 are configured and designed to boost signal strength and/or bandwidth through point-to-point line of sight communication between system components. This allows the TRV 22 to penetrate extreme distances through signal deprived environments without loss of the control signaling and electronic and RF communication between the control unit 29 and the TRV.

Additionally, the disclosed TRCPs 26 may be integrated with any type of sensor to provide remote networked detection and assessment capabilities. The disclosed TRCPs 26 and APD 28 create a safe and reliable network where the TRCPs may be expendable, provide secure communication, operate at high band widths, are rapidly deployable, may be warfighter wearable, may be intra-soldier wireless compatible, operate at low power, are small, and are lightweight. The TRCPs 26 also allow a field communication system to be modularly expandable, self-healing, and function as a MANET or mesh network.

Referring to FIG. 6, the disclosed system and apparatus can be used to perform a unique method of establishing, extending, and/or maintaining a communications network 24. In this example, the TRV 22 and the main controller 29 are deployed in a potentially signal deprived area or environment. The TRV 22 is operated using the controller 29 to move about the area or environment (S100). The communication signal or signals between the TRV 22 and the main controller 29 are monitored, such as for signal strength, quality or the like (S200). The monitored signal can be compared to a threshold value, such as a signal strength threshold (S300). The comparison can be manual, by the operator, or can be automatic, programmed as part of the system function for continuous automated monitoring. If the signal strength, quality, or the like is adequate, the operator can continue to operate the TRV 22 within the signal deprived area or environment (S300—NO).

If the signal strength, quality, or the like reaches, i.e., equals, or falls below the threshold value (S300—YES), the system can eject or dispense a TRCP 26 at the present location of the TRV 22 (S400). The ADP 28 can be operated manually and remotely by the operator from the main controller 29. Alternatively, the ADP 28, the controller 29, the TRV 22, or a combination thereof can be configured to operate automatically upon determining that the threshold value requirement has been met. Again, the TRV electronics, the ADP electronics, the controller electronics, or a combination thereof, may be configured and/or programmed to monitor the signal characteristics and to automatically eject and deploy a TRCP 26 when determined desirable to maintain communications between the TRV and the main controller.

Further, signal strength or signal quality is not intended to limit the threshold value to any particular signal characteristic. Instead, the system may monitor any signal transmitted to, from, or between the main controller and the TRV and determine, based on a characteristic of that signal, that the signal falls below the threshold value or level. The system can monitor any one or more of the different signals, including audio, video, sensor, or other signals from the TRV and make the determination to eject a TRCP based on that signal or any one of those monitored signals falling below the threshold value or level.

In other examples, the TRCP concept can be used in other applications as well. In one example, the TRCPs 26 may be used separately from the Tunnel Rat system 20. The TRCPs 26 may be carried by personnel to create a highly effective Intra-Soldier Wireless (warfighter worn) communications backbone device or network. The warfighter worn system transfers all the advantages and capabilities of the disclosed network directly to the warfighter and can include Access Point and Bluetooth communication. The network will again seamlessly and automatically heal itself and expand as personnel move in and out of the network. In this example, each warfighter may carry one TRCP 26 at all times whereby the network changes dynamically as the warfighters move about an area or region. The warfighter worn system can thus provide a dynamic and responsive communications network for all intra-soldier wireless devices.

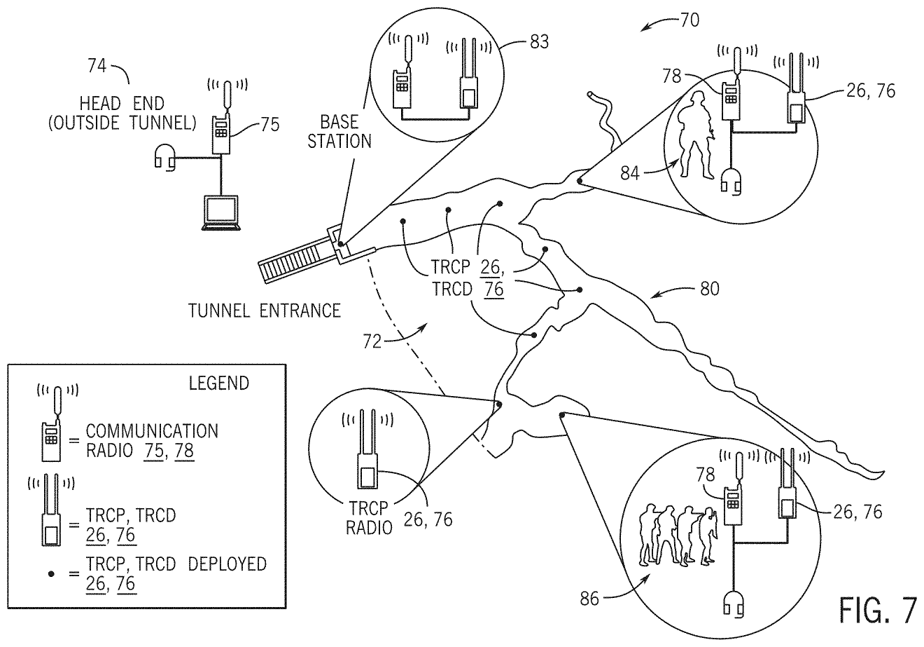

In another example, as depicted in FIG. 7, a Tunnel Rat system 70 may be configured that does not utilize a TRV or controller. Instead, the system 70 may be a wireless communication network 72 that includes a head end 74 with a main communication radio 75, a plurality of TRCPs 26 or a plurality of different Tunnel Rat communication devices or radios (TRCDs) 76, and one or more communication radios 78 carried by individual warfighters or personnel within a signal deprived environment. The Tunnel Rat system 70 includes the communication network 72, which may be formed in a manner similar to that described above for the network 24, except for the elimination of the TRV and controller. Instead, in this example, communication is intended between the head end 74 and main radio 75 and one or more TRCDs 76 carried by warfighters or personnel moving about in the signal deprived environment.

FIG. 7 illustrates a signal deprived environment, such as a tunnel system 80, to be investigated by warfighters or other personnel. The head end 74 is positioned outside of an entrance 82 to the tunnel system 80. The main communication radio 75 may be operated at the head end 74 by an operator outside of the tunnel system 80. A base station 83 may be established at the entrance 82 to the tunnel. The base station 83 may be manned by a warfighter or personnel having another communication radio 75 and a first deployed TRCP 26 or TRCD 76 set up to establish a signal between the base station 83 and the head end 74, if needed. A first warfighter 84 is shown as having moved along one branch of the tunnel system 80 to a position remote from the head end 74. A second group of warfighters 86 is shown as having moved along another branch of the tunnel system 80 to a position remote from the head end 74 and different from the position of the first warfighter 84. The first warfighter 84 and the second group of warfighters 86 may each carry a supply of TRCPs 26 or TRCDs 76. Though not shown, each may carry an ADP with a magazine or cartridge containing the supply of TRCPs 26 or TRCDs 76. Further, the ADP may be configured to automatically drop or release the TRCPs 26 or TRCDs 76, as needed. Alternatively, the warfighters 84, 86 may manually drop or release the TRCPs 26 or TRCDs 76 within and along the tunnel system 80, as needed.

As the warfighters 84 and 86 move along the tunnel system 80 away from the head end 74 and the base station 83, the communication signal between their respective radios 78 and the main communication radios 75 at the head end and base station, or directly between the radios 78 of the warfighter 84 and the group of warfighters 86, may weaken. As the signal reaches a minimum threshold signal, the warfighters 84 or 86 may drop or release a TRCP 26 or a TRCD 76 to establish and maintain the communication network 72 along the tunnel system 80. In one example, the warfighters 84, 86 carry a TRCP 26 or TRCD 76 that is not dropped. The TRCP or TRCD can be configured to prompt or signal to the operator and/or a warfighter that the communication signal has weakened to or near to the minimum threshold signal. Upon the prompt signal, the appropriate warfighter 84, 86 can manually drop or release one of the TRCPs 26 or TRCDs 76. Alternatively, an ADP carried by the appropriate warfighter 84, 86 may be configured to automatically do so. A shown in FIG. 7, the system 70 can include multiple deployed TRCPs 26 or TRCDs 76 within the tunnel system to establish and maintain the communication network 72 within the tunnel system 80. Once dropped or released, a deployed wireless communication device, i.e., a TRCP or TRCD, can be configured to automatically activate and join the network 72 or to be manually activated by a warfighter or personnel at the deployed location to join the network.

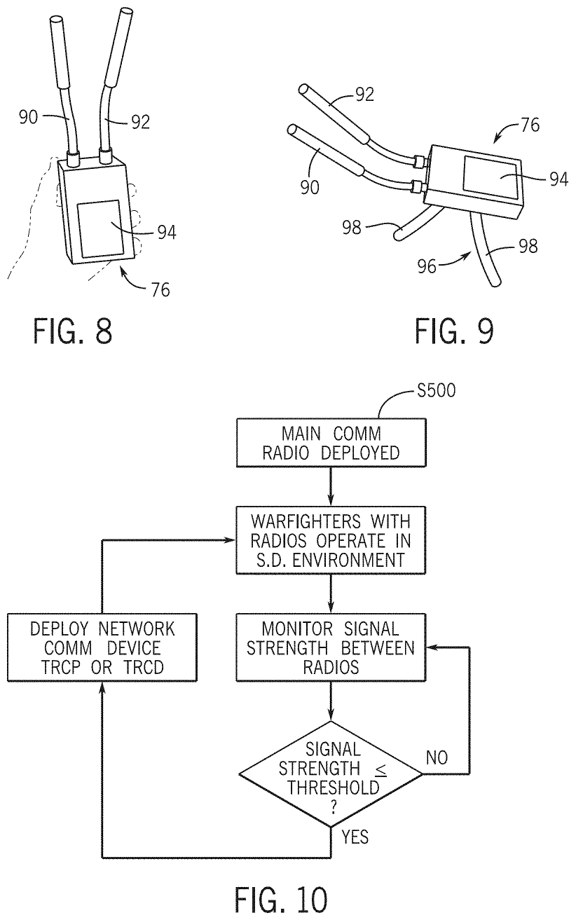

As shown in FIGS. 8 and 9, one example of a TRCD 76 is depicted in a carry configuration (FIG. 8) and in a deployed configuration (FIG. 9). The TRCD may have the same basic functionality as the above described TRCPs 26. In one example, the TRCD 76 may have two RF antennas 90, 92 for different communication frequencies, such as a 2.4 GHz antenna and a 5 GHz antenna. In one example, the antennas 90, 92 may be manually attachable to and removable from a body 94 of the TRCD 76. The body 94 may have (though not shown) a power ON button, a network port for hardwire network connection, a charging port for charging a battery of the TRCD, a signal or prompt generating element, and the like. The body 94 may be configured to include a display, a speaker, a vibration unit, and/or the like to provide a visual, audible, or physical signal to the warfighter or personnel that the wireless communication signal is weak or lost. In one example, the TRCD 76 may have a deployment structure 96 that can be configured to create a stand for the TRCD when deployed or that can be configured to attach or mount the deployed TRCD to another object. The deployment structure may vary considerably within the sprit and scope of this disclosure. As shown in FIG. 9, the deployment structure may include flexible legs 98 that can be bent or formed to create a stand or an attachment or mounting arrangement, as desired.

Referring to FIG. 10, the disclosed system 70 of FIG. 7 can be used to perform a unique method of establishing, extending, and/or maintaining a communications network 72. In this example, the main communication radio 75 is deployed at a base station 83 or head end 74 position in a potentially signal deprived area or environment (S500). One or more warfighters or personnel 84, 86 are fitted with communication radios 78 and a supply of TRCPs 26 or TRCDs 76 and move about the signal deprived environment (S600). The communication signal or signals between the main radio 75 and the one or more warfighter radios 78, or directly between two or more radios 78 of the warfighters 84, 86, are monitored, such as for signal strength, quality, or the like (S700). The monitored signal can be compared to a threshold value, such as a signal strength threshold (S800). The comparison can be manual, by the operator, by the warfighters, or can be automatic, programmed as part of the system function for continuous automated monitoring. If the signal strength, quality, or the like is adequate, the operator and/or warfighters can continue to operate and move about within the signal deprived area or environment (S800—NO).

If the signal strength, quality, or the like reaches, i.e., equals, or falls below the threshold value (S800—YES), the system 70 can be configured to effect deployment of a TRCP 26 or TRCD 76 at the location of the monitored warfighter. In one example, the system 70 can automatically eject or dispense a TRCP 26 or TRCD 76 from an ADP carried at the present location of the monitored warfighter (S900). The ADP can be configured to operate automatically upon determining that the threshold value requirement has been met. Instead, the system can be configured to signal the operator at the head end 74, the monitored warfighter, or both, that a TRCP 26 or TRCD 76 should be deployed. The ADP, if utilized, can thus be operated manually and remotely by the operator from the head end 74 or by the monitored warfighter at the deployment location. Alternatively, the warfighter can simply manually deploy the TRCP or TRCD when prompted. Again, the radio electronics, the ADP electronics, head end electronics, or a combination thereof, may be configured and/or programmed to monitor the signal characteristics and to automatically signal or prompt the operator or warfighter, or both, to manually or automatically eject and deploy a TRCP 26 or TRCD 76 when determined desirable to maintain communications between the TRV and the main controller. The prompt signal can be one or more of audible, visual, physical (vibration or the like), or another suitable signal method.

Again, signal strength or signal quality is not intended to limit the threshold value to any particular signal characteristic. Instead, the system may monitor any signal transmitted to, from, or between the main radio and the remote warfighter radios and determine, based on a characteristic of that signal, that the signal falls below the threshold value or level. The system can monitor any one or more of the different signals, including audio, video, sensor, or other signals and make the determination that a TRCP or TRCD should be deployed based on that signal or any one of those monitored signals falling below the threshold value or level. Further, the warfighters and the operator may share more than audio or radio signals. Similar to the system 20 and the TRV, the warfighters in the system 70 may carry equipment that includes video, sensors, and other data collection devices that can be monitored and shared with the operator at the head end 74.

Further, the head end, control unit, base station, or the like may vary within the scope of the present disclosure. The system may not have a head end or base station. These can simply represent a radio, communication device, or other network or device of some type at one end point of the network and system. In one alternate example, the network and system can push audio, video, data, and/or the like to a closed network across any and/or multiple Android Team Awareness Kits (ATAKs) and may share such data across all ATAK devices on the network and system.

In one example, a disclosed apparatus, system, and method provide radio-controlled vehicles or units (TRVs) to inspect caves, tunnels, bunkers, mountainous regions, urban environments, ships, and other dangerous, high-risk, and/or signal deprived environments without exposing operators to dangerous situations. The disclosed apparatus, system, and method eliminate the need for physical tethers between system components and alleviate the typical RF communication range and strength shortcomings. The disclosed apparatus, system, and method utilize a dispensing device to selectively deploy wireless communication devices where needed to provide point-to-point communication nodes to extend the communication range of a TRV and network.

In another example, a disclosed system and method provide continuous radio and network communication between a head end, a base station, or the like, and warfighters or personnel operating within such signal deprived environments. The disclosed system and method again eliminate the need for physical tethers between system components and again alleviate the typical RF communication range and strength shortcomings. The disclosed system and method utilize selectively deploying wireless communication devices where needed to provide point-to-point communication nodes to extend the communication range of the network.

The disclosed apparatus, systems, and methods utilize wireless communication devices that can be automatically actuated when deployed. The devices can allow an operator to create a communications network with self-healing capabilities. The disclosed apparatus, system, and method can utilize a unique software solution to monitor signal data via either (or in any combination) monitoring radio signal strength or Radio Signal Strength Indicator (RSSI), signal bandwidth, and/or Signal-to-Noise Ratio (SNR). The system can use the acquired signal data to automatically or manually dispense the wireless communication devices, as needed, based upon signal strength and/or quality and software parameters to assure uninterrupted communication with the head end or control unit and between a robotic vehicle or unit and the control unit.

The disclosed apparatus, systems, and methods can include two-way RF data communications. The communications can allow an operator to activate lights, cameras, audio systems, microphones, sensors, and other associated devices on a TRV. The disclosed apparatus, systems, and methods can be utilized via two-way voice or audio communication signals to allow an operator to interrogate and instruct personnel encountered by the TRV or radio-controlled vehicle or unit during a mission and/or to communicate with other personnel that are positioned remote from the operator.

The main controller 29 can be any type of computer or other electronic device that can be operated by a user to control the TRV and/or to communicate with warfighters or personnel in a signal deprived environment, as well as other aspects of the system and/or the network. The main controller 29 may include a memory, a hard drive, a processor, and the like, and may be connected to a network that includes the same, and/or a server, and/or the like. The main controller is not limited to any specific type of electronic device or mechanism.

The disclosed apparatus, systems, and methods, and embodiments, may be utilized for non-military use and in non-hostile environments. The disclosed apparatus, systems, and methods may be used to establish and maintain wireless communication in other types of signal deprived environments. Non-military personnel can deploy and use the disclosed embodiments as described herein, but without the high danger or hostile situations within a signal deprived environment. Likewise, in any of the disclosed embodiments, the wireless communication devices, such as the TRCPs or TRCDs, may be configured to automatically active when deployed in an environment or may be configured to be manually activated by the personnel when deployed in an environment.

Although certain apparatuses, systems, and methods have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A system for establishing and maintaining a communications network, the system comprising:
a main communication radio configured to be operated from a base location in or near a signal deprived environment;
one or more personnel radios configured to be carried by a corresponding number of personnel operating within the signal deprived environment;
a plurality of wireless communication devices configured to be carried by the personnel,
wherein each of the plurality of wireless communication devices can be selectively deployed as a deployed device within the signal deprived environment by the personnel, from the base location, or automatically through wireless communication with the base location based on a signal strength of a monitored signal falling to or below a minimum signal threshold, and
wherein the communications network is established and/or maintained between the main communication radio and the one or more personnel radios and/or between the one or more personnel radios through any one or more of the deployed devices of the plurality of wireless communication devices.

2. The system of claim 1, wherein each of the deployed devices of the plurality of wireless communication devices automatically activates when deployed.

3. The system of claim 1, wherein each of the deployed devices of the plurality of wireless communication devices is configured to be manually activated when deployed.

4. The system of claim 1, further comprising:
a dispensing device carried by the personnel, the dispensing device configured to hold and/or selectively eject or dispense the plurality of wireless communication devices.

5. The system of claim 4, wherein the dispensing device includes a magazine holding the plurality of wireless communication devices.

6. The system of claim 5, wherein a spent magazine can be replaced on the dispensing device with a loaded magazine.

7. The system of claim 5, wherein a spent magazine can be reloaded on the dispensing device with a plurality of wireless communication devices.

8. The system of claim 1, wherein the one or more personnel radios is equipped with one or more of video communication capability, audio communication capability, sensor capability, light emitting capability, and/or infra-red illumination or video capability.

9. The system of claim 1, wherein a signal reduction of the monitored signal is determined based on monitoring Signal-to-Noise Ratio (SNR), signal strength, signal bandwidth, Radio Signal Strength Indicator (RSSI), or any combination thereof.

10. The system of claim 1, wherein one of the plurality of wireless communication devices is configured to provide a signal or prompt that the signal strength of the monitored signal has fallen to or below the minimum signal threshold.

11. A method for establishing and maintaining a communications network, the method comprising:
operating, from a base location, a main communication radio, in or near a signal deprived environment;
having one or more personnel operating within the signal deprived environment and each carrying a personnel communication radio;
monitoring signal strength between the main communication radio and the personnel communication radios of the one or more personnel and/or between two of the personnel communication radios;
deploying a wireless communication device within the signal deprived environment before or upon detection of a signal reduction in the signal strength to or below a minimum signal strength threshold; and
further monitoring the signal strength as the one or more personnel operate within the signal deprived environment.

12. The method of claim 11, further comprising:
repeating, one or more times, the steps of monitoring, deploying, and further operating.

13. The method of claim 11, wherein the signal reduction is determined based on monitoring Signal-to-Noise Ratio (SNR), signal strength, signal bandwidth, Radio Signal Strength Indicator (RSSI), or any combination thereof.

14. The method of claim 11, wherein the one or more personnel communication radios is equipped with one or more of video communication capability, audio communication capability, sensor capability, light emitting capability, and/or infra-red illumination or video capability.

15. The method of claim 11, wherein upon being deployed, each deployed device of the plurality of wireless communication devices automatically activates when deployed.

16. The method of claim 11, wherein upon being deployed, each deployed device of the plurality of wireless communication devices is manually activated when deployed.

17. The method of claim 11, the step of deploying includes selectively deploying a wireless communication device as a deployed device within the signal deprived environment manually by a monitored personnel, from the base location, or automatically through wireless communication with the base location.

18. The method of claim 11, further comprising the step of providing a prompt or a signal to the one or more personnel being monitored when the signal reduction occurs.

19. The method of claim 18, wherein the step of providing the prompt or signal includes a communication device of a plurality of the wireless communication devices providing the signal or prompt.

20. A method for establishing and maintaining a communications network, the method comprising:
operating a main communication device in or near a signal deprived environment;
having another communication device operating within the signal deprived environment;
monitoring signal strength between the main communication device and the other communication device;
deploying a wireless communication device within the signal deprived environment before or upon detection of a signal reduction in the signal strength to or below a minimum signal strength threshold; and
further monitoring the signal strength as the other communication device operates within the signal deprived environment.
